(19) United States
(12) Patent Application Publication
(10) Pub. No.: US 2021/0319121 A1
(43) Pub. Date: Oct. 14, 2021

(54) CONCURRENT VOLUME AND FILE BASED INLINE ENCRYPTION ON COMMODITY OPERATING SYSTEMS

(71) Applicant: Intel Corporation, Santa Clara, CA (US)

(72) Inventors: Prashant Dewan, Portland, OR (US); Siddhartha Chhabra, Portland, OR (US); James Boyd, Hillsboro, OR (US); Hormuzd Khosravi, Portland, OR (US)

(73) Assignee: Intel Corporation, Santa Clara, CA (US)

(21) Appl. No.: 17/358,526

(22) Filed: Jun. 25, 2021

(51) Int. Cl. G06F 21/60; G06F 21/78; G06F 21/57

(52) U.S. Cl. CPC G06F 21/602; G06F 2221/0751; G06F 21/575; G06F 21/78

(57) ABSTRACT

The disclosure generally relates to method, system and apparatus for concurrent volume and file based inline encryption on commodity operating systems (OS). More particularly, some embodiments of the disclosure relate to a Converged Cryptographic Engine (CCE) for storage encryption. An exemplary method for implementing non-disruptive inline encryption of a read/write transaction on a non-volatile memory (NVM) circuitry includes the steps of: generating one or more encryption keys for the read/write transaction on a storage volume of the NVM circuitry at a Setup logic; identifying a plurality of Logical Block Addresses (LBAs) corresponding to the storage volume for the read/write transaction at an NTFS logic; and, at a Storage encryption system logic: (1) receiving the plurality of LBAs and their corresponding storage volume from the NTFS, (2) identifying the storage volume on the NVM storage circuitry for the read/write transaction, (3) identifying the one or more encryption keys for the identified storage volume, (4) assigning a keyId to the identified encryption key, and (5) programming the KeyId on to the NVM circuitry.

### FIELD

The disclosure generally relates to method, system and apparatus for concurrent volume and file based inline encryption on commodity operating systems (OS). More particularly, some embodiments relate to a Converged Cryptographic Engine (CCE) for storage encryption.

### BACKGROUND

With growing security needs, cryptographic engines have become a requirement for different usage models to protect code and/or data resident in main memory and Non-Volatile Memory (NVM or NVMe). Inline encryption has been used for encrypting files and volumes. The fundamental challenge with adding any new inline encryption mechanism is to make it work with the existing (storage) software stacks in legacy (or commodity) operating systems such as Linux® and Windows®. The inline encryption of conventional OS system requires disrupting the traffic flow or having to change the application that generates the traffic. Both of these options are disruptive for any hardware vendor offering NVMe inline encryption and any software vendor supplying the software stack. The conventional encryption techniques do not provide a method for non-disruptive inline encryption of a software stack.

### BRIEF DESCRIPTION OF THE DRAWINGS

So that the manner in which the herein recited features of the present embodiments can be understood in detail, a more particular description of the embodiments may be had by reference to embodiments, some of which are illustrated in the appended drawings. It is to be noted, however, that the appended drawings illustrate only typical embodiments and are therefore not to be considered limiting of their scope. In the drawings, similar elements are numbered similarly.

FIG. 1 is an exemplary algorithm for a conventional storage stack with volume encryption.

FIG. 2 illustrates a flow diagram and architecture for inline encryption of the files and volumes according to one embodiment of the disclosure.

FIG. 3 is a flow diagram of applying the disclosed principles to volume-level encryption according to one embodiment of the disclosure.

FIG. 4 is a flow diagram of applying the disclosed principles to file-level encryption according to one embodiment of the disclosure.

FIG. 5 schematically illustrates another embodiment of the disclosure in which Trusted Service Engine (TSE) is configured as part of the storage encryption system.

FIG. 6 illustrates generally an example of a block diagram of a machine upon which any one or more of the techniques (e.g., methodologies) discussed herein may perform in accordance with some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

NVMe (Non-Volatile Memory express) devices store data at rest (i.e., persistently) and this data has to be encrypted for security. In order to perform encryption in the System on Chip (“SOC”), the cryptographic (also referred to herein as “crypto” interchangeably) controller responsible for encryption in the SOC needs multiple pieces of information regarding the NVMe device including the LBA (Logical Block Address) of the NVMe device where the data is being stored. While some embodiments herein are discussed with reference to an NVMe, embodiments are not limited to NVMe, and other types of non-volatile memory may be used.

In various implementations, the information regarding the NVMe device may not be communicated to the host or the crypto controller in the DMA (Direct Memory Access) path. In other words, when the drive performs a DMA operation, it may not send this information to the host. Most NVMe drives used in personal computers have to use the PCIe (Peripheral Component Interface express (e.g., as maintained and developed by the PCI-SIG (PCI Special Interest Group)) protocol), and the PCIe protocol headers do not provide any mechanism for the drive to send additional information. This makes the problem of inline encryption using NVMe drives very tricky. As discussed herein, inline encryption implies that the encryption and decryption are occurring when the data is being read/written from the drive to DRAM or vice-versa. This is in contrast to lookaside encryption, where the NVMe controller writes data to memory and then some other agent reads plaintext data from memory, encrypts it and writes it back to memory or reads ciphertext from memory, decrypts it and writes plaintext to memory. As a result, the drive may not provide the information for encryption.

In the current software stacks, an application request of a write to file is parsed and a corresponding memory addresses and disk block addresses (e.g., LBA) are mapped by the filesystem. Subsequently, another driver in the stack (e.g., storage encryption system in Windows® is BitLocker) encrypts the memory pages. The Storage encryption system driver reads, the plaintext from the memory, encrypts it, and writes the ciphertext back to the memory. Once the cyphertext is generated, the volume manager maps the appropriate portion for the file (based on the application request), and the partition manager managers the appropriate partition in the volume. Subsequently, the data is written to the drive by the port and the storport (storage driver).

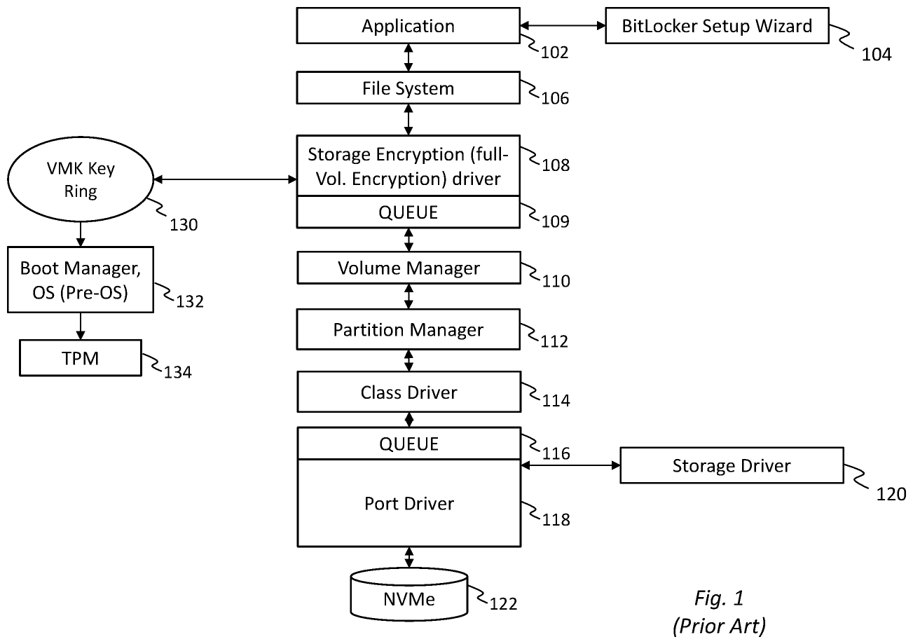

FIG. 1 is an exemplary algorithm for a conventional inline memory encryption. Specifically. FIG. 1 schematically illustrates inline encryption flow diagram for an OS software stack. While the flow diagram of FIG. 1 relates to the Microsoft® OS, the conventional operating systems have the substantially the same components.

In FIG. 1, application 102 communicates with Storage encryption system setup wizard 104. Application 102 may be any conventional OS application. Storage encryption system wizard setup 104 may define a driver to set up the data encryption process. The driver enables the users to encrypt an entire computer hard drive or removable storage disk, to protect the drive contents from malicious offline attacks.

The conventional Storage encryption system driver uses AES algorithm with 256 or 128-bit key to encrypt the desired content. The encryption prevents unauthorized users from reading, extracting, modifying or retrieving data in event of device theft or loss. The user must use the correct recovery key to access and decrypt data. Filesystem 106 may be software logic to provide files to be transparently encrypted and to protect confidential data from attackers with physical access to the computer. By default, no file is encrypted. But encryption can be enabled by users on a per-file, -directory or -drive basis. Storage encryption system full volume encryption driver 108 includes queue 109.

Volume Master Key (VMK) ring 130 is in communication with Storage encryption system driver 108. The VMK is encrypted by the appropriate key protector (not shown) and stored in the encrypted drive (not shown). If Storage encryption system has been suspended, the clear key that is used to encrypt the VMK is also stored in the encrypted drive, along with the encrypted volume master key. NMK 130. The Windows Boot Manager 132 is a Microsoft® Uniform Extensible Firmware Interface (UEFI) application that sets up the boot environment. Inside the boot environment, individual boot applications started by the Boot Manager provide functionality for all customer-facing scenarios before the device boots. Storage encryption system disk encryption conventionally requires a Trusted Platform Module (TPM) 134. TPM 134 may be a computer chip (or SoC) that helps enable temper-resistant full-disk encryption without requiring long passwords. The TPM generates encryption keys, keeping part of the key to itself. When using Storage encryption system encryption or device encryption on a computer with the TPM, part of the key is stored in the TPM itself, rather than just on the disk. This means an attackers cannot simply remove the drive from the computer and attempt to access its files elsewhere.

Referring again to FIG. 1, volume manager 110 builds virtual devices (or segments) called volumes on top of physical disks. Volumes are conventionally accessed by a UNIX file system, a database, or other applications in the same way physical disk partitions would be accessed. Volumes are composed of other virtual objects that can be manipulated to change the volume's configuration. Volumes and their virtual components are referred to as volume manager objects and they can be manipulated to optimize performance or to provide redundancy of data including data backup.

Partition manager 112 is a built-in tool that can be used to create, delete, format, shrink and extend disk partitions. Partition manager 112 is in communication with class driver 114. Class driver 114 is an intermediate driver to provide an interface between a vendor-written mini-driver and the OS. The mini-driver uses the class driver's device object to make system calls. Class driver 114 communicates to port driver 118 through queue 116.

In addition to the port driver, conventional OS systems include Storage driver which is a storage port driver especially suitable for use with high-performance buses, such as fiber channel buses and RAID adapters. The Storage driver is a more efficient, higher performance driver than SCSI Ports and connectors. The encrypted data is read/write onto database 122. The conventional methods, as illustrated in FIG. 1, do not provide means for inline encryption of the NVMe drive. The disclosed embodiments remedy this shortcoming.

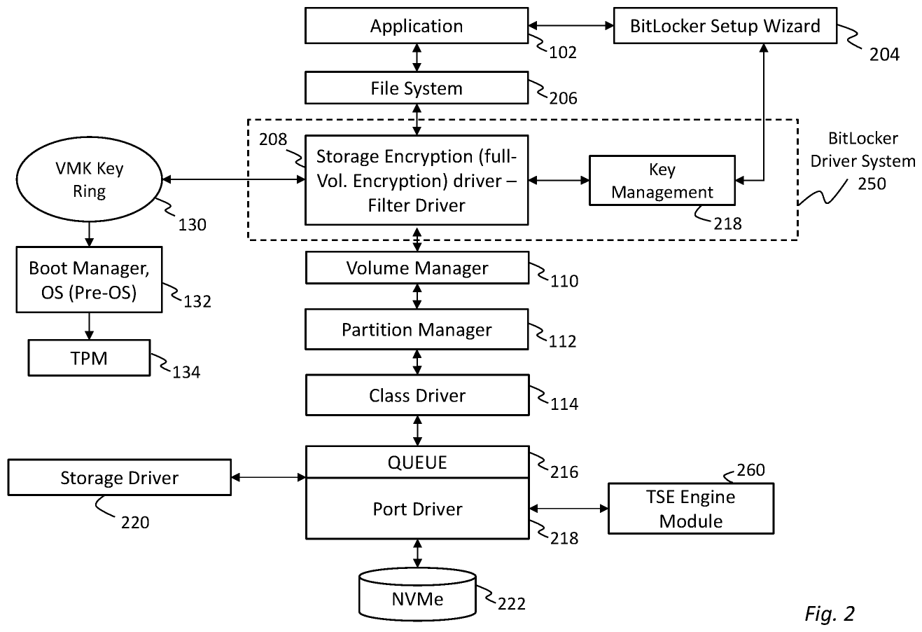

FIG. 2 illustrates a flow diagram and architecture for inline encryption of the NVMe according to one embodiment of the disclosure. For simplicity and brevity, several of the components of FIG. 2 are numbered identically to that of FIG. 1 and the description that follows illustrates some of the disclosed principles.

As illustrated in FIG. 2. Storage encryption system driver system 250 is schematically presented to incorporate key management system 218 and Storage encryption system driver/filter driver 208. Key management system 218 is configured to inject the keys into an inline encryption engine. In one embodiment of the disclosure, the keys are wrapped (i.e., made invisible to the software). In another embodiment, the keys are unwrapped (i.e., visible to the software). The Storage encryption system setup wizard 204 may actively and dynamically determine whether to wrap or not wrap the keys as a function of the application.

In one implementation, Storage encryption system setup wizard 204 generates software-generated and hardware-wrapped or hardware generated key blobs based on whether the NVMe drive is migratable or not. If the drive is migratable. Storage encryption system setup wizard 204 may wrap the keys and back it up. If the driver is not migratable, Storage encryption system setup wizard 204 may use hardware-generated keys. Once the keys (not shown) are generated, they are passed on to the Storage encryption system driver system 250 that configures the hardware with a table of indexes and keys. The Key Management Block generates the keys.

Once key management 218 delivers the generated keys, Storage encryption system 208 will implement the functionality vis-A-vis VMK Key ring 130 and the lower stacks of FIG. 2. The generated keys may be used in one of several different implementations. For example, the generated keys may be used for volume level encryption or for file level encryption.

Volume-Level Encryption

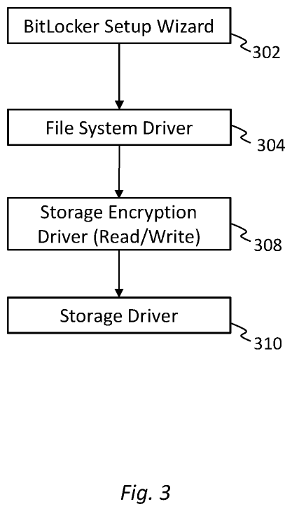

FIG. 3 is a flow diagram of applying the disclosed principles to volume encryption according to one embodiment of the disclosure. At step 302, Storage encryption system setup wizard 204 implements several exemplary steps. First, the Storage encryption system setup wizard 204 runs for each volume and generates a key for each volume. The Storage encryption system has to be configured on a per-volume basis. As a part of the configuration, the setup has to ‘run’ and configure each volume separately.

Reference is made to FIGS. 2 and 3 simultaneously. Next. Storage encryption system setup wizard 204 determines which key to apply to which volume. This may be considered as key mapping or maintaining a volume and applying a key thereto. Finally, Storage encryption system setup wizard 204 applies the key to the corresponding volume during each boot. That is. Storage encryption system setup wizard 204 sends the volume key to the Storage encryption system driver on every boot.

At step 304. File Encryption System (NTFS) driver (206. FIG. 2) identifies the volume and the LBAs for the transaction. Next. NTFS driver sends the volume. LBA information to the Storage encryption system driver 208 with every file read/write. At step 308. Storage encryption system driver 208 finds the volume for the transaction. Storage encryption system Driver 208 also finds the key for the given volume in the (volume→key) table which was provided by the Storage encryption system setup wizard 204 and assigns a keyId to the key. Storage encryption system Driver 208 repeats the step 308 for each read/write transaction. Storage encryption system Driver 208 then programs the Id→key mapping in the hardware and adds the keyId of the corresponding volume to the file transaction being executed.

Referring to FIG. 2, TSE Engine Module 260 represents the Total Storage Encryption Engine (TSE) and is a network-enabled software appliance based on web standards that enables secure file sharing across multiple security levels. Referring again to FIG. 3, at step 310 and when the transaction reaches Storage driver 220, the Storage driver makes a request to the TSE engine module 260 to add this key_id, LBAs, memory_pages to the TSE table. The TSE engine module provides the index and support driver adds the index to the TSE table to the higher order address bits. Next, the Storage driver 220 sends the transaction down the application stack.

Upon receiving a completion indication from port driver 218, Storage driver 220 requests the TSE engine module 260 to delete the line entry at the given index. Once the KeyId is added to the TSE table (not shown), the data is automatically encrypted on a memory (222, FIG. 2) read and decrypted on a memory write (DMA transactions).

File-Level Encryption

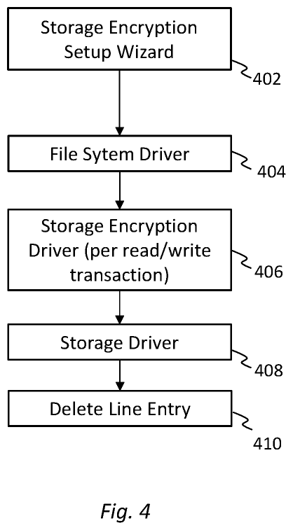

FIG. 4 is a flow diagram of applying the disclosed principles to file level encryption according to one embodiment of the disclosure. At step 402, Storage encryption system set up wizard (204. FIG. 2) runs for each volume and generates a key for each volume. Storage encryption system set up wizard also maps the volume to each corresponding key (volume→key) and maintains a volume/key mapping. Finally. Storage encryption system set up wizard 204 sends the volume→key mapping to the Storage encryption system driver 208.

At step 404, NTFS driver 206 finds the volume and the LBAs for the transaction and generates a tweak_value per file (or read the pre-stored tweak value from the file system). Next, NTFS driver 206 sends tweak_value, volume. LBA to the Storage encryption system driver with every file read/write. NTFS driver 206 also saves the tweak_value in the file_system with the index node (inode) of the file.

At step 406, Storage encryption system driver 208 performs the following processes: (1) functions finds the volume for the transaction; (2) find the key for the given volume in the volume→key table (provided by the Storage encryption system setup wizard); (3) assign a KeyId to the key; programs the KeyId in the hardware, and (4) add the KeyId and tweak_value of the corresponding volume to the file transaction going down. Steps 1-4 are repeated for each read/write transaction.

When the transaction reaches storage driver (step 408), Storage driver 310 makes a request to the TSE engine module 260 to add this KeyId, tweak_value and memory pages to the TSE Table (not shown). Then, TSE engine module 260 returns the index in the TSE table and Storage driver 220 adds the index of the TSE Table to higher order address bits.

Storage driver 220 then sends the transaction down the stack. Upon receiving completion from the port driver 218, Storage driver 220 requests the TSE engine module 260 to delete the line entry at the given index. Once the KeyId is added to the TSE Table, the data is automatically encrypted on a memory read and decrypted on a memory write as illustrated in step 410.

The disclosed embodiments provide significantly faster disk encryption without adding software complexity. The disclosed embodiments also enable file encryption. In fact, software can use the same mechanism to either implement file encryption or disk encryption without keeping two different pieces of encryption code. In addition, the disclosed embodiments provided both file level encryption and volume encryption in the same storage stack.

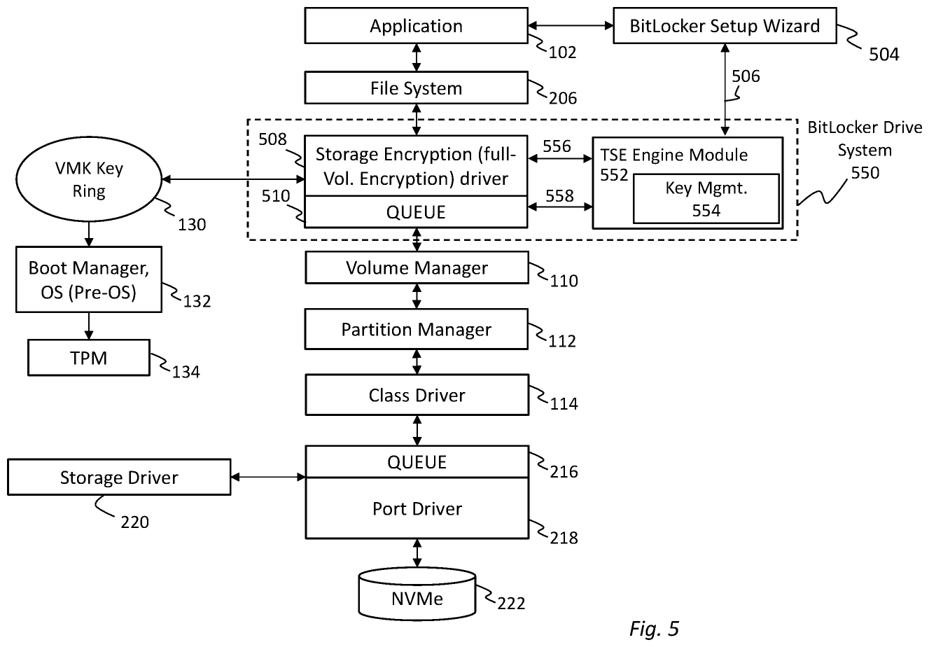

FIG. 5 schematically illustrates another embodiment of the disclosure in which TSE is configured as part of the Storage encryption system. In FIG. 5. Storage encryption system drive system 550 includes TSE engine module 552, key management module 554, Storage encryption system (full-volume encryption) driver 508 and queue 510. Storage encryption system Setup Wizard 504 configures TSE engine module 552 as indicted by arrow 506. TSE engine module 552 includes key management 554. TSE engine module 552 adds table entry to Storage encryption system 508 as indicated by arrow 556. TSE engine module 552 removes table entry from Storage encryption system 508 as indicated by arrow 558.

In the embodiment of FIG. 5, tasks that were done by Storage driver (220, FIG. 2) are now done by the Storage encryption system 508. This simplifies the storage driver's tasks 220 but it now requires Storage encryption system 508 to maintain queue 510 to know which transactions have been completed in order to request TSE engine module 552 to delete 558 the entry of completion of the transactions.

The disclosed principles may be implemented in hardware, software or a combination of hardware and software (i.e., firmware). For example, the components of FIGS. 1-5, including Application stack, Storage encryption system setup wizard. NTFS, Storage encryption system driver. Key management, VMK, Boot Manager, TPM, volume manager, partition manager, class driver, port driver, queue. TSE engine module and Storage driver may be implemented as computer logic or software component. NVMe or other memory circuitry may be implemented in hardware or software. In one embodiment, NVMe comprises one or more circuitries formed in hardware. In another component. NVMe comprises one or more circuitries formed in hardware and managed by software. Moreover, the systems described herein may be implemented in an Integrated Circuit (IC), a processor or on a System-on-Chip (SoC).

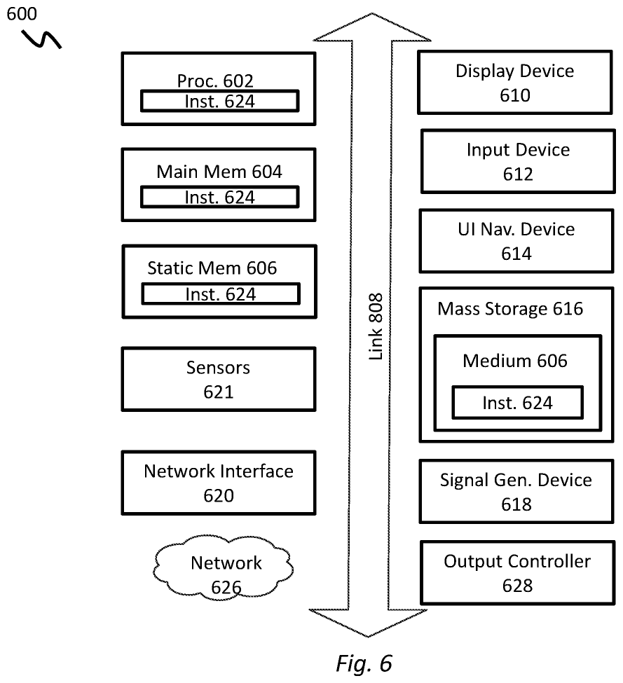

FIG. 6 illustrates generally an example of a block diagram of a machine upon which any one or more of the techniques (e.g., methodologies) discussed herein may perform in accordance with some embodiments. In FIG. 6 the machine 600 may operate as a standalone device or may be connected (e.g., networked) to other machines. In a networked deployment, the machine 600 may operate in the capacity of a server machine, a client machine, or both in server-client network environments. In an example, machine 600 may act as a peer machine in peer-to-peer (P2P) (or other distributed) network environment. The machine 600 may be a personal computer (PC), a tablet PC, a drone computing device, a control system, an IMU, a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 821, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM). Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks). Plain Old Telephone (POTS) networks, and wireless data networks (e.g., Institute of Electrical and Electronics Engineers (IEEE) 1502.11 family of standards known as Wi-Fi®, IEEE 602.16 family of standards known as WiMax®), IEEE 1502.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

In various embodiments, one or more operations discussed with reference to FIG. 1 et seq. may be performed by one or more components (interchangeably referred to herein as “logic”) discussed with reference to any of the figures. In various other embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

The following exemplary embodiments are provided to further illustrate the applications of the disclosed principles. The following examples are illustrative and non-limiting.

Example 1 is directed to an apparatus comprising: a processor circuitry and a memory circuitry in communication with the processor circuitry, the memory circuitry further comprising: a Setup logic to generate one or more encryption keys for the read/write transaction on a storage volume of the non-volatile memory (NVM) circuitry; an File System (FS) logic to identify a plurality of Logical Block Addresses (LBAs) corresponding to the storage volume for the read/write transaction; and a Storage encryption system logic configured to: receive the plurality of LBAs and their corresponding storage volume from the FS, identify the storage volume on the NVM storage circuitry for the read/write transaction, identify the one or more encryption keys for the identified storage volume, assign a keyId to the identified encryption key, and program the KeyId on to the NVM circuitry; wherein the apparatus provides non-disruptive inline encryption of a read/write transaction the NVM circuitry.

Example 2 is directed to the apparatus of Example 1, wherein inline encryption comprises encryption and decryption of data when the data is being read/written from the Storage encryption system logic to the NVM memory circuitry in real-time.

Example 3 is directed to the apparatus of Example 1, wherein the Setup logic generates one of a software-generated-hardware-wrapped encryption key or a hardware-generated key blob.

Example 4 is directed to the apparatus of Example 1, wherein the Setup logic generates one or more encryption keys for each storage volume and maintains a volume-to-encryption key mapping to identify the encryption key for each corresponding storage volume and wherein the Setup logic communicates the volume-to-encryption key mapping to the Storage encryption system logic on every system boot.

Example 5 is directed to the apparatus of Example 1, wherein the FS logic transmits the plurality of LBAs and their corresponding storage volume to the Storage encryption system logic for every read/write transaction.

Example 6 is directed to the apparatus of Example 1, wherein the file system logic generates a tweak_value per storage file or read a pre-stored tweak_value from the storage file and transmits the tweak_value, storage volume and corresponding LBAs to the Storage encryption system logic for each read/write transaction.

Example 7 is directed to the apparatus of Example 1, wherein the Storage encryption system logic receives a table of indexes and keys from the Setup logic and configures the NVM circuitry with a table of indexes and keys.

Example 8 is directed to the apparatus of Example 1, further comprising a Storage logic to instruct a Total Storage Encryption (TSE) logic to create and store a TSE table, the TSE table comprising the keyId, the plurality of LBAs and their corresponding volume, a tweak_value and a memory_page.

Example 9 is directed to the apparatus of Example 7, wherein the Storage logic deletes an entry corresponding to the read/write transaction upon completion of the read/write transaction.

Example 10 is directed to a method comprising: generating one or more encryption keys for the read/write transaction on a storage volume of a non-volatile memory (NVM) circuitry at a Setup logic to provide non-disruptive inline encryption of read/write transaction on the NVM; identifying a plurality of Logical Block Addresses (LBAs) corresponding to the storage volume for the read/write transaction at a file system logic; and at a Storage encryption system logic: receiving the plurality of LBAs and their corresponding storage volume from the file system, identifying the storage volume on the NVM storage circuitry for the read/write transaction, identifying the one or more encryption keys for the identified storage volume, assigning a keyId to the identified encryption key, and programming the KeyId on to the NVM circuitry.

Example 11 is directed to the method of Example 10, wherein inline encryption comprises encryption and decryption of data when the data is being read/written from the Storage encryption system logic to the NVM memory circuitry in real-time.

Example 12 is directed to the method of Example 10, wherein further comprising generating one of a software-generated-hardware-wrapped encryption key or a hardware-generated key blob at the Setup logic.

Example 13 is directed to the method of Example 10, further comprising generating one or more encryption keys for each storage volume and maintaining a volume-to-encryption key mapping to identify the encryption key for each corresponding storage volume at the Setup logic and communicating the volume-to-encryption key mapping to the Storage encryption system logic on every system boot.

Example 14 is directed to the method of Example 10, further comprising transmitting the plurality of LBAs and their corresponding storage volume to the Storage encryption system logic for every read/write transaction at the NTFS logic.

Example 15 is directed to the method of Example 14, wherein the NTFS logic generates a tweak_value per storage file or read a pre-stored tweak_value from the storage file and transmits the tweak_value, storage volume and corresponding LBAs to the Storage encryption system logic for each read/write transaction.

Example 16 is directed to the method of Example 10, wherein the Storage encryption system logic receives a table of indexes and keys from the Setup logic and configures the NVM circuitry with a table of indexes and keys.

Example 17 is directed to the method of Example 10, further comprising instructing a Total Storage Encryption (TSE) logic to create and store a TSE table, the TSE table comprising the keyId, the plurality of LBAs and their corresponding volume, a tweak_value and a memory_page.

Example 18 is directed to the method of Example 17, wherein the Storage logic deletes an entry corresponding to the read/write transaction upon completion of the read/write transaction.

Example 19 is directed to a non-transitory machine-readable medium including instructions which when executed on a processor cause the processor to implement operations comprising: generate one or more encryption keys for a read/write transaction on a storage volume of the Non-Volatile Memory (NVM) circuitry at a Setup logic; identify a plurality of Logical Block Addresses (LBAs) corresponding to the storage volume for the read/write transaction at a file system logic; and at a Storage encryption system logic: receive the plurality of LBAs and their corresponding storage volume from the file system, identify the storage volume on the NVM storage circuitry for the read/write transaction, identify the one or more encryption keys for the identified storage volume, assign a keyId to the identified encryption key, and program the KeyId on to the NVM circuitry; wherein the instructions provide non-disruptive inline encryption of the read/write transaction on the NVM circuitry.

Example 20 is directed to the medium of Example 19, wherein inline encryption comprises encryption and decryption of data when the data is being read/written from the Storage encryption system logic to the NVM memory circuitry in real-time and wherein the instructions further cause the processor to generate one of a software-generated-hardware-wrapped encryption key or a hardware-generated key blob at the Setup logic.

Example 21 is directed to the medium of Example 19, wherein the instructions further cause the processor to generate one or more encryption keys for each storage volume and maintain a volume-to-encryption key mapping to identify the encryption key for each corresponding storage volume at the Setup logic and communicate the volume-to-encryption key mapping to the Storage encryption system logic on every system boot.

Example 22 is directed to the medium of Example 19, wherein the instructions further cause the processor to transmit the plurality of LBAs and their corresponding storage volume to the Storage encryption system logic for every read/write transaction at the NTFS logic.

Example 23 is directed to the medium of Example 22, wherein the File System logic generates a tweak_value per storage file or read a pre-stored tweak_value from the storage file and transmits the tweak_value, storage volume and corresponding LBAs to the Storage encryption system logic for each read/write transaction.

Example 24 is directed to the medium of Example 22, wherein the Storage encryption system logic receives a table of indexes and keys from the Setup logic and configures the NVM circuitry with a table of indexes and keys and wherein the instructions further cause the processor to instruct a Total Storage Encryption (TSE) logic to create and store a TSE table, the TSE table having the keyId, the plurality of LBAs and their corresponding volume, a tweak_value and a memory_page.

Example 25 is directed to the medium of Example 24, wherein the Storage logic deletes an entry corresponding to the read/write transaction upon completion of the read/write transaction.

What is claimed is:

1. An apparatus comprising:
a processor circuitry and a memory circuitry in communication with the processor circuitry, the memory circuitry further comprising:
a Setup logic to generate one or more encryption keys for the read/write transaction on a storage volume of the non-volatile memory (NVM) circuitry;
an File System (FS) logic to identify a plurality of Logical Block Addresses (LBAs) corresponding to the storage volume for the read/write transaction; and
a Storage encryption system logic configured to:
receive the plurality of LBAs and their corresponding storage volume from the FS,
identify the storage volume on the NVM storage circuitry for the read/write transaction,
identify the one or more encryption keys for the identified storage volume,
assign a keyId to the identified encryption key, and
program the KeyId on to the NVM circuitry;
wherein the apparatus provides non-disruptive inline encryption of a read/write transaction the NVM circuitry.

2. The apparatus of claim 1, wherein inline encryption comprises encryption and decryption of data when the data is being read/written from the Storage encryption system logic to the NVM memory circuitry in real-time.

3. The apparatus of claim 1, wherein the Setup logic generates one of a software-generated-hardware-wrapped encryption key or a hardware-generated key blob.

4. The apparatus of claim 1, wherein the Setup logic generates one or more encryption keys for each storage volume and maintains a volume-to-encryption key mapping to identify the encryption key for each corresponding storage volume and wherein the Setup logic communicates the volume-to-encryption key mapping to the Storage encryption system logic on every system boot.

5. The apparatus of claim 1, wherein the FS logic transmits the plurality of LBAs and their corresponding storage volume to the Storage encryption system logic for every read/write transaction.

6. The apparatus of claim 1, wherein the file system logic generates a tweak_value per storage file or read a pre-stored tweak_value from the storage file and transmits the tweak_value, storage volume and corresponding LBAs to the Storage encryption system logic for each read/write transaction.

7. The apparatus of claim 1, wherein the Storage encryption system logic receives a table of indexes and keys from the Setup logic and configures the NVM circuitry with a table of indexes and keys.

8. The apparatus of claim 1, further comprising a Storage logic to instruct a Total Storage Encryption (TSE) logic to create and store a TSE table, the TSE table comprising the keyId, the plurality of LBAs and their corresponding volume, a tweak_value and a memory_page.

9. The apparatus of claim 7, wherein the Storage logic deletes an entry corresponding to the read/write transaction upon completion of the read/write transaction.

10. A method comprising:
generating one or more encryption keys for the read/write transaction on a storage volume of a non-volatile memory (NVM) circuitry at a Setup logic to provide non-disruptive inline encryption of read/write transaction on the NVM;
identifying a plurality of Logical Block Addresses (LBAs) corresponding to the storage volume for the read/write transaction at a file system logic; and
at a Storage encryption system logic:
receiving the plurality of LBAs and their corresponding storage volume from the file system,
identifying the storage volume on the NVM storage circuitry for the read/write transaction,
identifying the one or more encryption keys for the identified storage volume,
assigning a keyId to the identified encryption key, and
programming the KeyId on to the NVM circuitry.

11. The method of claim 10, wherein inline encryption comprises encryption and decryption of data when the data is being read/written from the Storage encryption system logic to the NVM memory circuitry in real-time.

12. The method of claim 10, wherein further comprising generating one of a software-generated-hardware-wrapped encryption key or a hardware-generated key blob at the Setup logic.

13. The method of claim 10, further comprising generating one or more encryption keys for each storage volume and maintaining a volume-to-encryption key mapping to identify the encryption key for each corresponding storage volume at the Setup logic and communicating the volume-to-encryption key mapping to the Storage encryption system logic on every system boot.

14. The method of claim 10, further comprising transmitting the plurality of LBAs and their corresponding storage volume to the Storage encryption system logic for every read/write transaction at the NTFS logic.

15. The method of claim 14, wherein the NTFS logic generates a tweak_value per storage file or read a pre-stored tweak_value from the storage file and transmits the tweak_value, storage volume and corresponding LBAs to the Storage encryption system logic for each read/write transaction.

16. The method of claim 10, wherein the Storage encryption system logic receives a table of indexes and keys from the Setup logic and configures the NVM circuitry with a table of indexes and keys.

17. The method of claim 10, further comprising instructing a Total Storage Encryption (TSE) logic to create and store a TSE table, the TSE table comprising the keyId, the plurality of LBAs and their corresponding volume, a tweak_value and a memory_page.

18. The method of claim 17, wherein the Storage logic deletes an entry corresponding to the read/write transaction upon completion of the read/write transaction.

19. A non-transitory machine-readable medium including instructions which when executed on a processor cause the processor to implement operations comprising:
generate one or more encryption keys for a read/write transaction on a storage volume of the Non-Volatile Memory (NVM) circuitry at a Setup logic;
identify a plurality of Logical Block Addresses (LBAs) corresponding to the storage volume for the read/write transaction at a file system logic; and
at a Storage encryption system logic:
receive the plurality of LBAs and their corresponding storage volume from the file system,
identify the storage volume on the NVM storage circuitry for the read/write transaction,
identify the one or more encryption keys for the identified storage volume,
assign a keyId to the identified encryption key, and
program the KeyId on to the NVM circuitry;
wherein the instructions provide non-disruptive inline encryption of the read/write transaction on the NVM circuitry.

20. The medium of claim 19, wherein inline encryption comprises encryption and decryption of data when the data is being read/written from the Storage encryption system logic to the NVM memory circuitry in real-time and wherein the instructions further cause the processor to generate one of a software-generated-hardware-wrapped encryption key or a hardware-generated key blob at the Setup logic.

21. The medium of claim 19, wherein the instructions further cause the processor to generate one or more encryption keys for each storage volume and maintain a volume-to-encryption key mapping to identify the encryption key for each corresponding storage volume at the Setup logic and communicate the volume-to-encryption key mapping to the Storage encryption system logic on every system boot.

22. The medium of claim 19, wherein the instructions further cause the processor to transmit the plurality of LBAs and their corresponding storage volume to the Storage encryption system logic for every read/write transaction at the NTFS logic.

23. The medium of claim 22, wherein the File System logic generates a tweak_value per storage file or read a pre-stored tweak_value from the storage file and transmits the tweak_value, storage volume and corresponding LBAs to the Storage encryption system logic for each read/write transaction.

24. The medium of claim 22, wherein the Storage encryption system logic receives a table of indexes and keys from the Setup logic and configures the NVM circuitry with a table of indexes and keys and wherein the instructions further cause the processor to instruct a Total Storage Encryption (TSE) logic to create and store a TSE table, the TSE table having the keyId, the plurality of LBAs and their corresponding volume, a tweak_value and a memory_page.

25. The medium of claim 24, wherein the Storage logic deletes an entry corresponding to the read/write transaction upon completion of the read/write transaction.
